(19) United States
(12) Patent Application Publication
(10) Pub. No.: US 2025/0305951 A1
(43) Pub. Date: Oct. 2, 2025

(54) METHOD AND SYSTEM FOR DETERMINING A POSE, AND METHOD FOR PRODUCING A DIFFRACTIVE OPTICAL ELEMENT

(71) Applicant: Carl Zeiss AG, Oberkochen (DE)

(72) Inventors: Ulrich Vogl, Aalen (DE); Nils Haverkamp, Aalen (DE); Carsten Glasenapp, Oberkochen (DE)

(21) Appl. No.: 19/236,843

(22) Filed: Jun. 12, 2025

Related U.S. Application Data
(63) Continuation of application No. PCT/EP2023/085021, filed on Dec. 11, 2023.

(30) Foreign Application Priority Data
Dec. 15, 2022 (DE) 10 2022 133 508.9

(51) Int. Cl. G01N 21/47; G02B 27/42

(52) U.S. Cl. CPC G01N 21/4788; G02B 27/4205; G01N 2201/06113

(57) ABSTRACT

Methods and systems are for determining a pose. The methods and systems capture at least one two-dimensional diffraction pattern caused by diffracting coherent radiation at a diffractive element in the far field. The diffractive element has a non-periodic volumetric diffraction structure. A pose of the diffractive element is determined based on the at least one two-dimensional diffraction pattern and data dependent on the non-periodic volumetric diffraction structure.

### CROSS-REFERENCE TO RELATED APPLICATIONS

This application is a continuation application of international patent application PCT/EP2023/085021, filed Dec. 11, 2023, designating the United States and claiming priority from German application 10 2022 133 508.9, filed Dec. 15, 2022, and the entire content of both applications is incorporated herein by reference.

### TECHNICAL FIELD

The disclosure relates to pose determination methods and systems. The disclosure also relates to production methods and production systems configured for producing components of pose determination systems. The disclosure relates in particular to pose determination methods and systems that use electromagnetic radiation, and components therefor.

### BACKGROUND

Pose determination for elements has numerous applications, for example in manufacturing technology or medical engineering. One field of application is pose determination for workpieces (that is, determination of the degrees of translational and rotational freedom). This can be performed conventionally using tactile methods or without contact.

Techniques of contactless pose determination for an element require certain compromises. For example, in the case of camera tracking systems with a plurality of cameras or interferometric techniques, there is interplay between achievable accuracy and achievable spatial dynamic range (that is, a detection volume and/or solid angle range). It is challenging to achieve high accuracy over a large detection volume and/or a large solid angle range.

For camera-based detection with one camera, a signature for a deflection in one degree of freedom in general cannot be clearly distinguished from deflections in other degrees of freedom. For example, this can be partially overcome by the use of a plurality of cameras. Incoherently illuminated camera tracking systems are an example in this respect. In addition, a relatively high accuracy is often achievable in two translative coordinates in the case of incoherently illuminated systems, but the resolution for the remaining direction is often much worse.

The use of coherent illumination may offer improvements in relation to these disadvantages of incoherent illumination systems. A measurement of the relative phase angle of the wave trains involved also allows a reconstruction of the pose in the depth direction, that is, along the beam direction, with interferometric accuracy.

In addition to the achievable precision in up to six degrees of freedom, the various conventional methods also differ in terms of the absolute accuracy that can be achieved in each case. Typically, intrinsic and extrinsic camera parameters are calibrated by way of a known test standard. In multi-camera systems, an absolute position of the individual cameras can be calibrated from this, and an absolute pose of the target object for the pose determination can be derived accordingly therefrom. In the case of single-camera systems and pose determination targets including repetitive grating structures, absolute pose determination is generally only possible using additional measurement techniques.

Hence the technology still needs improved methods and systems of pose determination for a target object. In particular, there is a need for systems and methods that offer improvements in regard to the achievable accuracy and/or dynamic range in which pose determination is possible. In particular, there is a need for such systems and methods that allow determination of an absolute pose (absolute translational position and/or rotational position relative to a reference system) with high accuracy. There is also a need for elements that can be used in such pose determination methods, and a need for production methods for such elements.

### SUMMARY

According to one aspect, the disclosure relates to a pose determination system. The pose determination system includes the following: a diffractive element including a nonperiodic volumetric diffraction structure, at least one detector configured for detecting at least one two-dimensional diffraction pattern caused by diffraction of coherent radiation at the diffractive element in a far field, and an evaluation device configured to determine a pose of the diffractive element on the basis of the at least one two-dimensional diffraction pattern and data which are dependent on the nonperiodic volumetric diffraction structure.

The use of coherent radiation for contactless pose determination makes it possible to achieve a high accuracy in all degrees of freedom. The use of an element including a nonperiodic volumetric diffraction structure makes it possible to determine absolute values for the pose (that is, position values and/or rotation relative to a coordinate system that can be defined by the at least one detector). The embodiment of the nonperiodic structure as a nonperiodic volumetric diffraction structure facilitates pose determination over a relatively large dynamic range, in particular a relatively large solid angle range.

The evaluation of the two-dimensional diffraction pattern or the plurality of two-dimensional diffraction patterns takes place using knowledge about the nonperiodic volumetric diffraction structure. As a result, the present techniques differ from conventional speckle methods, for example, in which no knowledge about an embodiment of the diffraction structure is present and usable in the evaluation. The data about the nonperiodic volumetric diffraction structure can define an arrangement of scattering centers in the element, for example. The data about the nonperiodic volumetric diffraction structure can be transferred into the evaluation device for example from a manufacturing system used to manufacture the element or the diffraction structure in the element.

The diffractive element can be configured in such a way that the at least one two-dimensional diffraction pattern arising at the at least one detector is uniquely assignable to a pose of the diffractive element in a detection volume.

For this purpose, for example, the nonperiodic volumetric diffraction structure can be defined in a manner depending on dimensions of the detection volume, a desired solid angle range of possible rotations of the element and a detector area of the at least one detector.

This can ensure that a unique pose determination in the desired dynamic range is possible for the respective available detector configuration.

The diffractive element can be configured in such a way that it generates no repetitions of the two-dimensional diffraction pattern of the coherent radiation over a predetermined volume and/or over a predetermined solid angle range.

This can ensure that a unique pose determination in the desired dynamic range is possible for the respective available detector configuration.

The system can include a further redundant measuring system in order to resolve possible ambiguities of the two-dimensional diffraction pattern.

The diffractive element can be configured in such a way that it causes a diffraction pattern over a solid angle range of at least 2π, more than 2π, more than 3π or 4π.

This enables a pose determination even when the element rotates in a correspondingly large solid angle range.

The diffractive element can include a transparent or translucent material in which scattering centers of the diffraction structure are formed.

The diffractive element can include a glass or a quartz material in which the at least one diffraction structure is formed.

A good temperature stability of the measuring technique can be achieved as a result.

The diffractive element can include a material, for example a glass or quartz material with high temperature stability, with a CTE value of no more than 100 ppb/K, no more than 50 ppb/K, no more than 20 ppb/K or no more than 10 ppb/K at room temperature.

A good temperature stability of the measuring technique can be achieved as a result.

The diffractive element can have a faceted surface, for example a surface with one or more polyhedron portions.

This can facilitate diffraction into a relatively large solid angle range.

The diffraction structure can include a pseudo-randomly distributed structure, wherein the data used by the evaluation device are dependent on the pseudo-randomly distributed structure. In other words, scattering centers can be randomly or pseudo-randomly distributed in the configuration process for the element, but the embodiment of the diffraction structure is deterministic in the sense that it is known and can be used in the evaluation of the two-dimensional diffraction pattern or the two-dimensional diffraction patterns.

This facilitates a configuration of the element which enables a unique assignment of the pose with high accuracy even over a relatively large dynamic range, for example a relatively large detection volume and/or a relatively large solid angle range of possible rotations of the element.

The evaluation device can be configured to computationally determine at least three degrees of freedom of the diffractive element for the pose determination. The evaluation device can be configured to computationally determine three translational degrees of freedom and/or three rotational degrees of freedom of the diffractive element for the pose determination.

As a result, all degrees of freedom that are relevant to the respective application can be determined.

The evaluation device can be configured, for the pose determination, to compare the at least one two-dimensional diffraction pattern with a plurality of two-dimensional reference diffraction patterns which are determined from calibration measurements or are ascertained computationally depending on the nonperiodic volumetric diffraction structure. The evaluation device can be configured to computationally ascertain the reference diffraction patterns from the data which are dependent on the diffraction structure. For this purpose, a forward propagation of the coherent radiation can be ascertained computationally. In order to reduce the computational complexity, a coarse estimation of the pose can be used to reduce the parameter space to be sampled for which the reference diffraction patterns are to be determined computationally.

The evaluation device can be configured, for the pose determination, to process the at least one two-dimensional diffraction pattern captured by the at least one detector, using a trained machine learning model. As a result, the pose determination can be carried out without expert knowledge with the aid of the trained machine learning model. The machine learning model can include an input layer, which receives pixel values of the at least one two-dimensional diffraction pattern captured by the at least one detector. The machine learning model can include an output layer, which outputs information concerning the pose. The use of the machine learning model can be combined with the above-described forward propagation for calculating expected reference diffraction patterns. By way of example, the machine learning model can be configured in such a way that it receives both the captured at least one two-dimensional diffraction pattern and a reference diffraction pattern and, as output, outputs an indicator reflecting a probability that the captured at least one two-dimensional diffraction pattern corresponds to the same pose as the reference diffraction pattern.

The evaluation device can be configured, for the pose determination, to carry out an approximative procedure for pose determination. The approximative procedure can include an iterative procedure. The approximative procedure can include an iterative refinement of an estimation of the pose. The estimation can be provided by a further measuring unit of the system, this unit operating with lower resolution. Consequently, a result of the further measuring unit can be refined by the evaluation of the at least one captured two-dimensional diffraction pattern in combination with the data which are dependent on the diffraction structure. The approximative procedure can also include the use of an element which, in addition to the nonperiodic volumetric diffraction structure, includes a further diffraction structure, which can be periodic and enables the pose to be estimated.

The system can include at least one source of the coherent radiation, which is configured to radiate the coherent radiation onto the diffractive element.

The at least one source of the coherent radiation can include a laser that generates and outputs the coherent radiation or at least one wavelength component of the coherent radiation.

The at least one source can be configured to radiate coherent radiation having a plurality of different wavelengths onto the diffractive element. The coherent radiation can include a first radiation component having a first wavelength and a second radiation component having a second wavelength. The at least one detector can be configured to capture the different wavelengths in different channels.

As a result, the accuracy of the pose determination can be increased further.

The first radiation component and the second radiation component are each coherent and can advantageously be phase-stable with respect to one another.

As a result, the accuracy of the pose determination can be increased further. In particular, interference effects between the radiation components can be used to generate one or more synthetic wavelengths and use them in the pose determination.

The at least one source of the coherent radiation can include one source, which outputs both the first radiation component and the second radiation component. The at least one source of the coherent radiation can include a first source, which generates and outputs the first radiation component, and a second source, which generates and outputs the second radiation component. The at least one source of the coherent radiation can be phase-locked. The at least one source of the coherent radiation can include a frequency comb generator.

The use of such sources enables the desired determination of the absolute pose to be effected.

The at least one source can be arranged in a stationary fashion with respect to the diffractive element. For example, both the source (that is, an end of an optical fiber coupled to a laser or to a frequency comb) and the diffractive element can be attached to the same carrier. For example, the carrier can be a workpiece, a tool or a medical instrument whose pose in a detection volume is intended to be determinable over a certain spatial region of rotations.

By using a source arranged in a stationary fashion relative to the diffractive element, the generation of the diffraction patterns and their evaluation can be facilitated. In particular, there is no longer the need for updating a beam axis of the coherent radiation in accordance with the current translational position of the diffractive element.

The diffractive element can be arranged in a movable fashion relative to the at least one source. A tracking mechanism of the system can be configured to update a beam axis of the coherent radiation such that the coherent radiation is incident on the diffractive element.

The system can be or include an industrial manufacturing system, an industrial measuring system or a medical engineering system.

The system can include a robot or any other actuator or an actuator chain, for example a multi-axis robot, which is controllable in order to change a translational position and/or an angular alignment of a workpiece, tool or medical instrument. The pose of the workpiece, tool or medical instrument can be determined using the system according to the disclosure. In this case, the diffractive element can be arranged on the workpiece, tool or medical instrument or on a movable component of the robot.

The system can include a human-machine interface, via which a result of the pose determination can be output.

Alternatively or additionally, the system can be configured to use a result of the pose determination to control at least one actuator. The system can be configured in such a way that an industrial manufacturing process, an industrial quality control and/or a medical engineering instrument are/is influenced by the control of the at least one actuator.

According to a further aspect of the disclosure, a method for producing a diffractive element for pose determination is specified, wherein the method includes: determining a nonperiodic volumetric diffraction structure, controlling a production device for producing the diffractive element including the nonperiodic volumetric diffraction structure, and providing data which are dependent on the nonperiodic volumetric diffraction structure for use in determining a pose of the diffractive element.

Such a diffractive element is configured for use in the pose determination systems and methods according to the disclosure. Such an element allows an absolute pose to be determined with high accuracy over a relatively large dynamic range. The production method furthermore also provides data which are subsequently used in the pose determination. The data can include information about the arrangement of scattering centers of the nonperiodic volumetric diffraction structure.

The method can be a method for providing the diffractive element and data for use in determining a pose of the diffractive element. Accordingly, the method for providing the diffractive element and data for use in determining a pose of the diffractive element can include: determining a nonperiodic volumetric diffraction structure, controlling a production device for producing the diffractive element including the nonperiodic volumetric diffraction structure, and providing data which are dependent on the nonperiodic volumetric diffraction structure for use in determining a pose of the diffractive element.

The following optional features can find application both in the method for producing a diffractive element for pose determination and in the method for providing the diffractive element and data for use in determining a pose of the diffractive element.

The nonperiodic volumetric diffraction structure can be determined and produced in such a way that the at least one two-dimensional diffraction pattern arising at the at least one detector is uniquely assignable to a pose of the diffractive element in a detection volume.

For this purpose, for example, the nonperiodic volumetric diffraction structure can be defined in a manner depending on a radius of the detection volume, a desired solid angle range of possible rotations of the element and a detector area of the at least one detector.

This can ensure that a unique pose determination in the desired dynamic range is possible for the respective available detector configuration.

The nonperiodic volumetric diffraction structure can be determined and produced in such a way that it generates no repetitions of the two-dimensional diffraction pattern of the coherent radiation over a predetermined volume and/or over a predetermined solid angle range.

This can ensure that a unique pose determination in the desired dynamic range is possible for the respective available detector configuration.

The diffractive element can be produced in such a way that it causes a diffraction pattern over a solid angle range of at least 2π, more than 2π, more than 3π or 4π.

This enables a pose determination even when the element rotates in a correspondingly large solid angle range.

The diffractive element can be produced in such a way that it includes a transparent or translucent material in which scattering centers of the diffraction structure are formed.

This enables a pose determination over a relatively large solid angle range. Shading by the element at which the coherent radiation is diffracted is avoided—in contrast to reflective techniques.

The diffractive element can be produced in such a way that it has a faceted surface, for example a surface with one or more polyhedron portions.

This can facilitate diffraction into a relatively large solid angle range.

The production device can include a device for laser writing of the nonperiodic volumetric diffraction structure. Alternatively or additionally, the production device can include a device for three-dimensional printing of the diffractive element.

The production method can include securing the diffractive element to a component of an industrial system or of a medical engineering system.

According to a further aspect of the disclosure, a diffractive element including a nonperiodic volumetric diffraction structure is specified.

The diffractive element can be produced by the production method according to one aspect or embodiment.

The diffractive element can be configured in such a way that the at least one two-dimensional diffraction pattern arising at the at least one detector is uniquely assignable to a pose of the diffractive element in a detection volume.

For this purpose, for example, the nonperiodic volumetric diffraction structure can be defined in a manner depending on a radius of the detection volume, a desired solid angle range of possible rotations of the element and a detector area of the at least one detector.

This can ensure that a unique pose determination in the desired dynamic range is possible for the respective available detector configuration.

The diffractive element can be configured in such a way that it generates no repetitions of the two-dimensional diffraction pattern of the coherent radiation over a predetermined volume and/or over a predetermined solid angle range.

This can ensure that a unique pose determination in the desired dynamic range is possible for the respective available detector configuration.

The diffractive element can be configured in such a way that it causes a diffraction pattern over a solid angle range of at least 2π, more than 2π, more than 3π or 4π.

This enables a pose determination even when the element rotates in a correspondingly large solid angle range.

The diffractive element can include a transparent or translucent material in which scattering centers of the diffraction structure are formed.

The diffractive element can have a faceted surface, for example a surface with one or more polyhedron portions.

This can facilitate diffraction into a relatively large solid angle range.

According to a further aspect of the disclosure, a pose determination method is specified, including: capturing, via at least one detector, at least one two-dimensional diffraction pattern caused by diffraction of coherent radiation at the diffractive element in the far field, wherein the diffractive element includes a nonperiodic volumetric diffraction structure, and determining a pose of the diffractive element on the basis of the at least one two-dimensional diffraction pattern and data which are dependent on the nonperiodic volumetric diffraction structure.

The method can be carried out by the pose determination system according to one embodiment.

Further optional features of the pose determination method and the effects achieved therewith in each case correspond to the features and effects described with reference to the system.

According to an aspect, the disclosure relates to an evaluation device for a pose determination system. The evaluation device includes the following: an interface for receiving at least one two-dimensional diffraction pattern caused by diffraction of coherent radiation at a diffractive element in a far field, and a processing circuit configured to determine a pose of the diffractive element on the basis of the at least one two-dimensional diffraction pattern and data which are dependent on the nonperiodic volumetric diffraction structure.

Further optional features of this evaluation device and the effects achieved therewith in each case correspond to the optional features described with reference to the pose determination system.

According to a further aspect of the disclosure, machine-readable instruction code is specified, which, when executed by a programmable computing unit, carries out the method according to one aspect or embodiment of the disclosure.

According to a further aspect of the disclosure, a storage medium with machine-readable instruction code stored thereon is specified, the machine-readable instruction code, when executed by a programmable computing unit, carrying out the method according to one aspect or embodiment of the disclosure.

The methods, systems and system components according to embodiments of the disclosure achieve various effects. The determination of an absolute pose is made possible. The absolute pose determined according to the disclosure can include up to three translational degrees of freedom and/or up to three rotational degrees of freedom relative to a coordinate system that is defined by the at least one detector. In comparison with various conventional methods for absolute pose determination, the pose determination can be implemented with a greater accuracy and in a larger dynamic range.

The methods, systems and system components can be used in various sectors. This includes pose determination in an industrial environment, for example pose determination in industrial manufacturing and/or quality control. The methods, systems and system components can also be used in the context of medical engineering devices or medical engineering systems.

### BRIEF DESCRIPTION OF DRAWINGS

The invention will now be described with reference to the drawings wherein:

FIG. 1 shows a pose determination system according to one embodiment;

FIG. 2 shows the system from FIG. 1 after an optical element has been translationally displaced and rotated;

FIG. 3 shows an evaluation device of a system according to one embodiment;

FIG. 4 shows a schematic illustration of a machine learning structure that the evaluation device can optionally include;

FIG. 5 is a flowchart of a method according to one embodiment;

FIG. 6 is a flowchart of a method according to one embodiment;

FIG. 7 is a schematic illustration of a diffractive element which can be used in systems and methods according to embodiments;

FIG. 8 shows a pose determination system according to one embodiment;

FIGS. 9 and 10 illustrate a mode of operation of the pose determination system;

FIGS. 11 and 12 illustrate a mode of operation of the pose determination system;

FIGS. 13 and 14 illustrate a mode of operation of the pose determination system;

FIGS. 15 and 16 show radiation sources which can be used in pose determination systems and methods according to the disclosure;

FIG. 17 shows a system according to one embodiment;

FIG. 18 is a flowchart of a production method according to one embodiment;

FIG. 19 shows a block diagram for explaining a mode of operation of a production method for an optical element according to one embodiment; and,

FIG. 20 shows a schematic illustration of a diffractive element which can be used in systems and methods according to embodiments.

### DETAILED DESCRIPTION

Embodiments of the disclosure will be described with reference to the figures. In the figures, similar or identical reference signs denote elements with similar or identical embodiment and/or function.

While embodiments are described in the context of position determination in industrial settings or in medical engineering, the systems and methods described here are not restricted to these fields of application.

The features of the embodiments can be combined with one another, unless this is expressly precluded in the following description.

Pose determination methods and systems according to embodiments allow an absolute pose of an optical element to be determined. Determination of an absolute pose is understood here to mean the determination of up to three translational and/or up to three rotational degrees of freedom relative to a reference system, wherein the diffractive element is movable relative to the reference system. For example, the reference system can be defined by one or more detectors used in pose determination for the capture of two-dimensional diffraction patterns.

The determined pose can be the pose of the optical element or, derived therefrom, the pose of a rigid part connected to the optical element, for example a workpiece, tool or surgical instrument.

Pose determination methods and systems use two-dimensional diffraction patterns in the far field to carry out the pose determination. Coherent radiation is radiated onto the diffractive element in the process. According to the art, a far field of a two-dimensional diffraction pattern caused by the diffraction structure is understood here to mean, in particular, a distance between the detector and the diffraction structure which allows a computational determination of the two-dimensional diffraction pattern using the Fraunhofer approximation. The detector or each of the detectors used to capture two-dimensional diffraction patterns for example can be at a distance from the diffractive element of at least two times the wavelength of the coherent radiation, at least three times the wavelength of the coherent radiation, at least five times the wavelength of the coherent radiation or at least ten times the wavelength of the coherent radiation. If coherent radiation having a plurality of wavelengths is used, the aforementioned minimum distance can be determined depending on a longest wavelength which is captured by at least one detector and is subsequently evaluated by an evaluation device in order to determine the pose.

The two-dimensional patterns can be respective granular interference patterns.

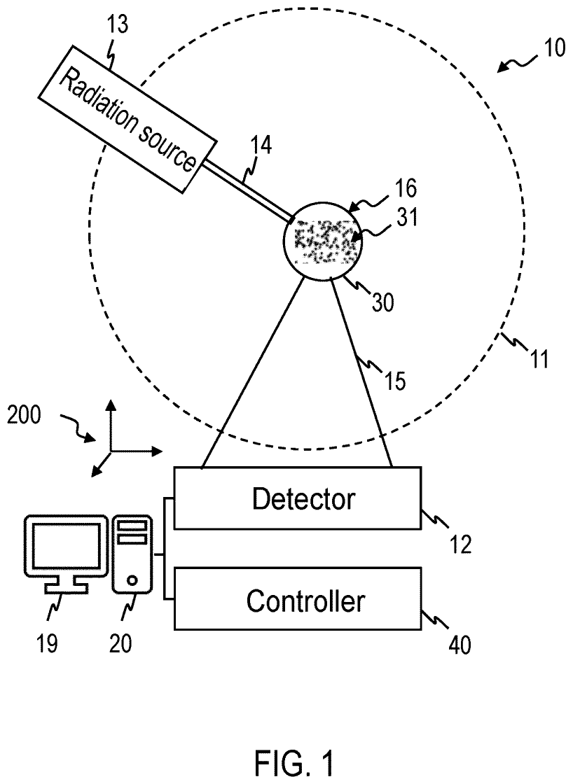

FIG. 1 shows a pose determination system 10. The system 10 is configured to determine an absolute pose of a diffractive element 30 in a detection volume 11. The system 10 can be configured to determine both a translational position and a rotation of the diffractive element 30 relative to a coordinate system 200 defined by at least one detector 12.

The system 10 includes at least the diffractive element 30, one or more detectors 12 and an evaluation device 20.

The diffractive element 30 includes a nonperiodic volumetric diffraction structure 31. The nonperiodic volumetric diffraction structure 31 can be formed by laser writing or three-dimensional printing, for example. The diffractive element 30 can optionally include further structures, in particular a further diffraction structure, in addition to the nonperiodic volumetric diffraction structure 31. This further diffraction structure can be periodic and can be used, for example, to ascertain an initial estimation of the pose, which is subsequently refined by the techniques described in detail below.

The detector or the plurality of detectors 12 is/are configured to capture at least one two-dimensional diffraction pattern generated by diffraction of coherent radiation 14 at the diffractive element 30. The detector or the plurality of detectors 12 is/are configured to capture the at least one two-dimensional diffraction pattern in the far field in order to facilitate a computational pose determination. For this purpose, the detector or the detectors 12 can be arranged around the detection volume 11 at a distance from the diffractive element 30, and in particular at a distance from the nonperiodic volumetric diffraction structure 31. The position of each detector 12 can be defined such as to ensure that the two-dimensional diffraction pattern in the far field is captured by the detector 12 for each pose of the diffractive element 30 in the detection volume 11.

Each detector 12 can include a two-dimensional arrangement of sensor pixels. The sensor pixels can be arranged in a detector area. Various sensors known in the art can be used. If the coherent radiation 14 includes different radiation components having different wavelengths, each detector 12 can include a plurality of color channels. The plurality of color channels can correspond to the different wavelengths but, if the different radiation components are phase-stable with respect to one another, can also include at least one color channel that corresponds to a synthetic wavelength generated by the coherent superposition of two radiation components that are phase-stable with respect to one another.

The coherent radiation diffracted at the diffractive element 30 is schematically represented as radiation 15 incident on the detector 12.

The evaluation device 20 is configured to evaluate one or a plurality of two-dimensional diffraction patterns captured by the detector or the detectors 12. For pose determination from the at least one two-dimensional diffraction pattern, the evaluation device 20 also uses data which are dependent on the nonperiodic volumetric diffraction structure 31 and which can define a configuration of the diffraction structure 31. For example, the data used can originate from a production process for the nonperiodic volumetric diffraction structure 31. The data can define an arrangement of scattering centers in the nonperiodic volumetric diffraction structure 31 such as is generated by laser writing or 3D printing, for example.

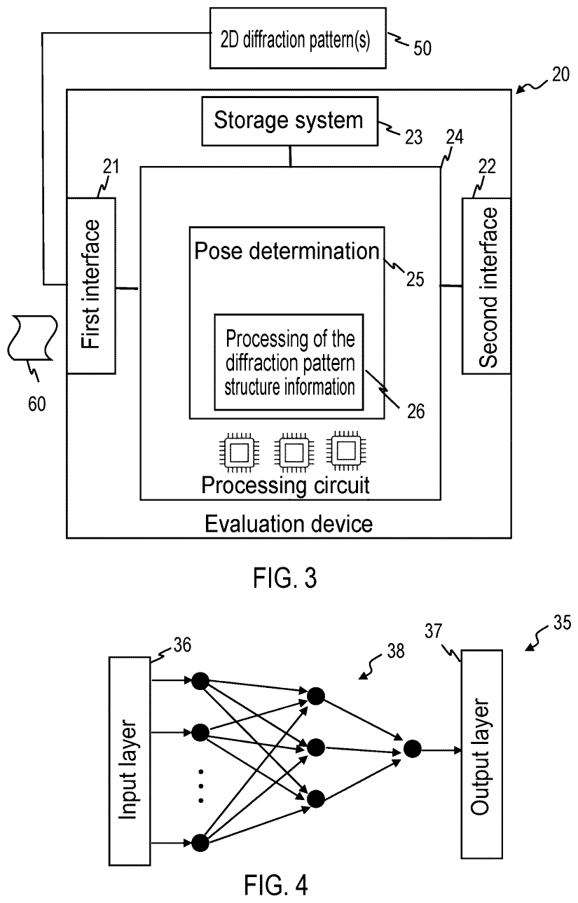

Further features and modes of operation of the evaluation device 20 are described in greater detail below with reference to FIG. 3 to FIG. 6.

The system 10 can include a radiation source 13, which radiates the coherent radiation 14 onto the diffractive element 30. The radiation source 13 can include one or more lasers. The radiation source 13 can be configured to radiate coherent radiation having exactly one wavelength onto the diffractive element 30. The exactly one wavelength can be fixedly or time-dependently determinable.

The radiation source 13 can be configured to radiate coherent radiation 14 having radiation components including a plurality of different wavelengths onto the diffractive element 30. In this case, each of the different radiation components can include exactly one wavelength. The radiation source 13 can include a plurality of lasers, for example a plurality of mode-locked lasers. The radiation source 13 can include at least one frequency comb generator.

The system 10 can include one or more components that make further use of the pose ascertained by the evaluation device 20. FIG. 1 schematically illustrates a human-machine interface 19 and a controller 40, which are able to receive and represent the determined pose from the evaluation device 20 or use the pose for a control process. The controller 40 can be a controller of at least one actuator from a system of industrial manufacturing or industrial quality control or a medical engineering system.

The evaluation device 20 can be configured to output the ascertained pose to the human-machine interface 19, for example in order to output the pose visually.

The evaluation device 20 can be configured to output the ascertained pose to the controller 40 in order to enable control of at least one actuator in accordance with a control loop.

The evaluation device 20 can include a network interface and can be configured to transmit the ascertained pose via a local area network or a wide area network. For example, this can be done to document the poses and/or monitor the system 10 from a remote position.

In the case of the situation illustrated in FIG. 1, the diffractive element 30 is situated at a position 16 in a coordinate system 200 in which the detector 12 is arranged in a stationary fashion. In the case of the situation illustrated in FIG. 1, the diffractive element 30 is situated in a first rotational orientation in the coordinate system 200.

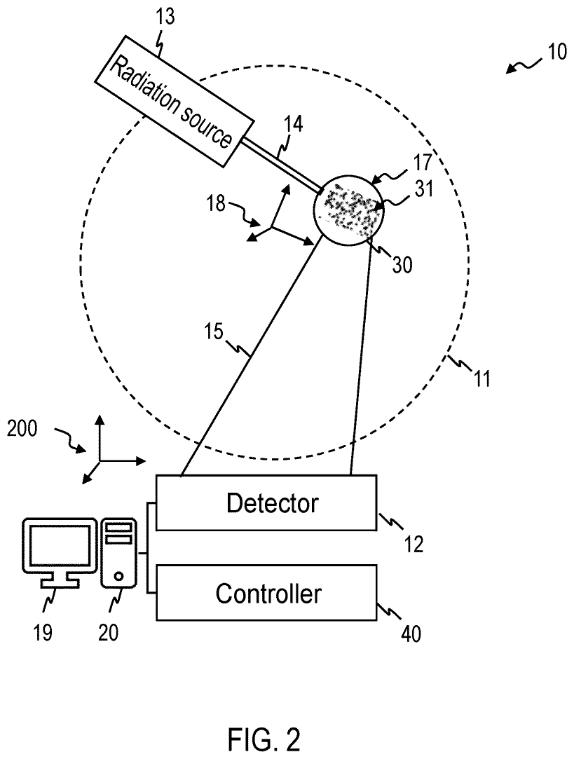

FIG. 2 shows the system 1 after the diffractive element 30 has moved translationally to a second position 17 in the coordinate system 200.

The translational movement from the first position 16 to the second position 17 leads to a change in the two-dimensional diffraction pattern. The system 10 can be configured to determine the first position 16 and the second position 17 in absolute terms in each case, wherein the two-dimensional diffraction pattern captured in each case is evaluated. The second position 17, in particular also a plurality of translational coordinates of the second position, can be determined without needing to use the two-dimensional diffraction pattern captured by the detector 12 while the diffractive element was at the first position 16.

As illustrated schematically in FIG. 2, an object coordinate system 18 of the diffractive element 30 can rotate relative to the coordinate system 200. The rotation relative to the coordinate system 200 can be determined by up to three rotational degrees of freedom, which can be specified by three Euler angles, for example. The rotational position is also referred to here as “orientation” in order to allow a simple conceptual distinction from the translational position.

The system 10 can be configured to determine the orientation of the diffractive element 30 in absolute terms in each case, wherein the two-dimensional diffraction pattern captured in each case is evaluated. A first orientation of the diffractive element (FIG. 1) can be determined from at least one first two-dimensional diffraction pattern that is captured when the diffractive element is in the first orientation. A second orientation of the diffractive element (FIG. 2) can be determined from at least one second two-dimensional diffraction pattern that is captured when the diffractive element is in the second orientation; this second orientation can be determined independently of the at least one first two-dimensional diffraction pattern.

The pose determination system according to the disclosure and the pose determination method carried out by the system achieve various advantages over conventional methods that make use of coherent radiation. One such conventional method is so-called speckle localization, in which a partially reflective object is illuminated with coherent radiation, and the resultant interference pattern is compared with a reference measurement. The geometry of the partially reflective surface from speckle localization is generally unknown. Therefore, the conventional method requires reference measurements for absolute pose determination. The partially reflective surface from conventional speckle localization also restricts the solid angle over which the pose can be determined. In addition, on the detector side speckle localization has the restriction that for a correlative reconstruction of the change in pose, the characteristic interference pattern from the reference measurement may only be displaced by no more than the field of view of the camera, or complex additional reference measurements are alternatively required.

The pose determination system and method according to the disclosure, on the other hand, allow determination of the absolute pose without necessarily requiring reference measurements. The data which are dependent on the nonperiodic volumetric diffraction structure 31 can be used to computationally determine the expected diffraction pattern or the expected diffraction patterns for any arbitrary pose in the dynamic range, which pattern(s) can then be compared with the at least one captured two-dimensional diffraction pattern. The high resolution of coherent measurement methods is maintained in the process.

The pose determination techniques according to the disclosure have, inter alia, the effect that the accuracy of a coherent measurement method is maintained, but a greater solid angle coverage is made possible. The techniques according to the disclosure also allow definition of a configuration specification and relevant manufacturing parameters for the diffractive element 30 such that the desired pose determination in the dynamic range is possible. The techniques according to the disclosure also allow a measurement specification for transferring an accuracy, which is embodied by the diffractive element 30, to the coordinate system 200 of the detector and, overall, to the pose determination (in up to 6 degrees of freedom or 6 dimensions of the pose space) of the diffractive element 30.

The diffractive element 30 can be structured in such a way that a diffraction pattern is generated under coherent illumination in the far field. The diffractive element 30 can be structured in such a way that the generated diffraction pattern in the far field allows a one-to-one assignment of the pose of the diffractive element.

The diffractive element 30 includes a non-periodic optical grating or some other nonperiodic volumetric diffraction structure 31. A periodic grating or some other periodic diffraction structure under coherent illumination has the property that a local interference pattern in a detector plane is not uniquely assignable to one pose. This disadvantage can be overcome with the nonperiodic grating or some other nonperiodic volumetric diffraction structure.

In order to ascertain a suitable configuration for the nonperiodic volumetric diffraction structure, a required information content of the diffraction structure can be estimated as follows: A surface of the detection volume 11 can be subdivided into partial areas that each have the size of a detector area of one of the detectors 12. Each of these partial areas can be assigned a unique, spatially discrete “target” diffraction pattern. In this context, a useful reference parameter is the pixel size of the detector used. From this initial target diffraction pattern, a reciprocal distribution which corresponds to the required grating volume of the coherently illuminated diffractive element 30 can be calculated using a discrete Fourier transform. A minimum generable structure size (which may depend on a pixel dimension of the detector 12, for example) and a desired maximum size of the diffractive element 30 into which the diffraction structure is introduced can be used as boundary conditions. Additional boundary conditions can be taken into account when determining the nonperiodic volumetric diffraction structure.

The structure ascertained as described above, at which the coherent radiation is scattered, defines a producible diffractive element. For the diffraction structure, both the far-field diffraction pattern and the scattering centers of the diffractive element can be arranged quasi-randomly. Nevertheless, the diffraction structure is known and fully computable. This represents a difference to speckle localization, in which the geometry of the partially reflective surface is generally unknown.

For the manufacture of such a diffractive element 30, this allows a targeted construction and verification of the spatial structure of the diffractive element 30. For example, microscopic methods can be used for this purpose. Additionally or alternatively, a verification of the two-dimensional diffraction pattern in one or more detector planes is made possible.

A technical advantage of this procedure is that one or a few detectors can be used to determine poses that can cover a large solid angle, optionally even the full solid angle range. For this purpose, the evaluation device 20 can compare the captured two-dimensional diffraction pattern or the captured two-dimensional diffraction patterns with a calculated reference diffraction pattern of the diffractive element. Since the diffraction structure has been specifically produced and/or data defining the diffraction structure are available to the evaluation device 20, the reference diffraction patterns can be calculated by forward propagation.

Another technical advantage of the technique according to embodiments is that the three-dimensional volumetric diffraction structure can be realized in materials such as glasses or quartz materials with a low coefficient of thermal expansion. This ensures improved insensitivity to temperature changes. Known glasses with low thermal expansion can be used. For example, it is possible to use glasses or quartz materials that have a coefficient of thermal expansion (CTE) value of no more than 100 ppb/K, no more than 50 ppb/K, no more than 20 ppb/K, or no more than 10 ppb/K at room temperature (23° C.). Thus, a diffractive element 30 in the order of 1 cm can achieve an accuracy of the measurement standard of <1 nm within a temperature band of 1 K. Projected on a detection plane of the detector 12 or the detectors 12, a lateral accuracy of the pose of <1 μm can be achieved.

The diffractive element 30 can be configured such that it generates diffraction images in a solid angle range of at least 2π, at least 3π or the full solid angle range of 4π. Shading may be accepted.

As will be described in even greater detail below, some requirements in respect of the diffractive element 30 and in particular in respect of the nonperiodic volumetric diffraction structure 30 can be relaxed.

For example, it is not mandatory for a two-dimensional diffraction pattern linked one-to-one with a pose to be formed on a detection surface of a detector 12 over the entire surface of the detection volume 11. Ambiguities may be accepted. Ambiguities may be able to be resolved for example using a redundant measuring system.

In addition to the nonperiodic volumetric diffraction structure 31, the diffractive element 30 can include at least one further diffraction structure, for example a periodic grating, which is used for the resolution of any ambiguities and/or for determining an initial estimation of the pose. The different diffraction structures can differ in terms of a mean distance vis-à-vis structure elements.

With the use of coherent radiation including radiation components having at least two different wavelengths, the techniques disclosed herein can be carried out independently for a plurality of color channels. This relaxes the requirements in respect of the diffraction structure. A much simpler diffraction structure can be used, since the combination of diffraction patterns from different color channels can be used for pose determination. If the radiation components having different wavelengths are phase-stable with respect to one another, synthetic wavelengths that further increase the accuracy can moreover result from interference.

It is not necessary to embody the diffractive element 30 in such a way that it can radiate diffraction patterns over the entire solid angle range of 4π. For example, radiation into a smaller solid angle range, for example into a half-space, can be sufficient for numerous applications. Alternatively, a plurality of diffractive elements 30 can be combined on a carrier, for example on different side surfaces of an industrial or medical tool, wherein each of the diffractive elements 30 radiates into a solid angle range that is smaller than the solid angle range of 4π; however, the use of the plurality of diffractive elements 30 nevertheless makes it possible to determine the pose of the carrier over the entire solid angle range.

The mode of operation of the evaluation device 20 for systems and methods according to embodiments is described in more detail below.

FIG. 3 shows the evaluation device 20 of the system according to one embodiment.

The evaluation device 20 includes at least one first interface 21, via which one or a plurality of two-dimensional diffraction patterns 50 are received. The at least one first interface 21 can be communicatively connected to the detector 12 or the detectors 12, either directly or via a data network, for example a wireless or wired local area network. Via the at least one first interface 21, the evaluation device 20 can also receive data 60 which are dependent on the nonperiodic volumetric diffraction structure 31. These data 60 can specify a distribution of scattering centers in the diffraction structure 31 as defined in the manufacture of the diffractive element 30 and written into the diffractive element 30. The data 60 can include a configuration file for the manufacture of the diffractive element 30, the file being used in the manufacturing process.

The evaluation device 20 includes a processing circuit 24. The processing circuit 24 is configured to computationally process the two-dimensional diffraction patterns 50 and the data 60 which are dependent on the configuration of the nonperiodic volumetric diffraction structure 31. This allows the pose in the detection volume 11 to be determined.

Pose determination 25 carried out by the processing circuit 24 can include processing 26 of the data 60 which can define the nonperiodic volumetric diffraction structure 31. This allows a reference diffraction pattern determined computationally from the data 60 for a hypothetical pose of the diffractive element 30 to be compared with the captured two-dimensional diffraction pattern 50. The processing 26 of the data 60 can computationally determine reference diffraction patterns for a plurality of candidate poses in order to compare each of these with the captured two-dimensional diffraction pattern 50.

Results of the pose determination 25 and in particular results of the processing 26 of the data 60, such as the determination of the reference diffraction patterns from the data 60, can be stored in a storage system 23 of the evaluation device 20 for further use and can be retrieved from there as necessary by the processing circuit 24.

The processing circuit 24 can include one or more integrated circuits to perform the required processing of the two-dimensional diffraction patterns and data 60. The one or more integrated circuits can for example include any desired one or any desired combination of the following circuits or circuit components: an application-specific integrated circuit (ASIC), a field-programmable gate array (FPGA), a processor, a controller, one or more quantum gates, a circuit for quantum information processing, further integrated circuits.

A result of the pose determination can be output via the at least one first interface 21 or via a second interface 22, differing therefrom, of the evaluation device 20. For example, the result can be output to a human-machine interface or a controller of an industrial or medical engineering system.

The evaluation device 20 can make use of at least one trained machine learning model 35 in order to carry out the pose determination.

FIG. 4 is a schematic illustration of a machine learning model 35 which can be executed by the evaluation device 20. The machine learning model 35 includes an input layer 36, a plurality of hidden layers 38 and an output layer 37.

The input layer 36 can be configured to receive pixel values of the at least one diffraction pattern captured by the at least one detector. The output layer 37 can be configured to output information about the pose.

In a further embodiment, the input layer 36 can be configured to receive both pixel values of at least one two-dimensional diffraction pattern captured by the at least one detector and reference pixel values ascertained computationally, wherein the reference pixel values are ascertained computationally from the data 60 about the diffraction structure 31. The output layer 37 can then output a probability value indicating whether the captured two-dimensional diffraction pattern corresponds to the same pose for which the reference pixel values have been ascertained computationally.

A technical advantage of the techniques described here is that labeled data required for training the machine learning model 35 can be ascertained computationally in large numbers from the data 60 about the diffraction structure 31. For example, a two-dimensional reference diffraction pattern expected at the detector 12 or the detectors 12 for the corresponding pose can be determined computationally by forward propagation methods for each of a multiplicity of possible poses of the diffractive element 30 in the detection volume 11. This computationally determined reference diffraction pattern can then be labeled with the known pose for which the forward propagation was performed. During training, which may make use of conventional techniques such as gradient-based methods, the machine learning model 35 can be trained to the effect of assigning the correct pose to each of the reference diffraction patterns, by setting the adjustable parameters of the machine learning model 35.

More complex techniques can be used to realize the trained machine learning model 35. For example, generative adversarial networks (GANs) can be used to form and train the machine learning model 35.

The use of a machine learning model is optional. The evaluation device 20 can solve an inverse problem of reconstruction from the momentum space to the position space for determining the pose in different ways.

The evaluation device 20 can be configured for example to computationally determine the expected diffraction pattern or the expected diffraction patterns (if a plurality of color channels are used and/or a plurality of detectors are used) for any desired candidate pose. A comparison with the captured two-dimensional diffraction pattern can then be carried out. The expected diffraction patterns, which are also referred to as reference diffraction patterns, can be stored in the evaluation device 20 or a separate storage system in order to minimize latencies in the pose determination.

The evaluation device 20 can alternatively or additionally be configured to use machine learning techniques. In this case, constellations resulting from the pose in the detection volume 11 can be recognized in full or in part. Possible implementations have already been described above.

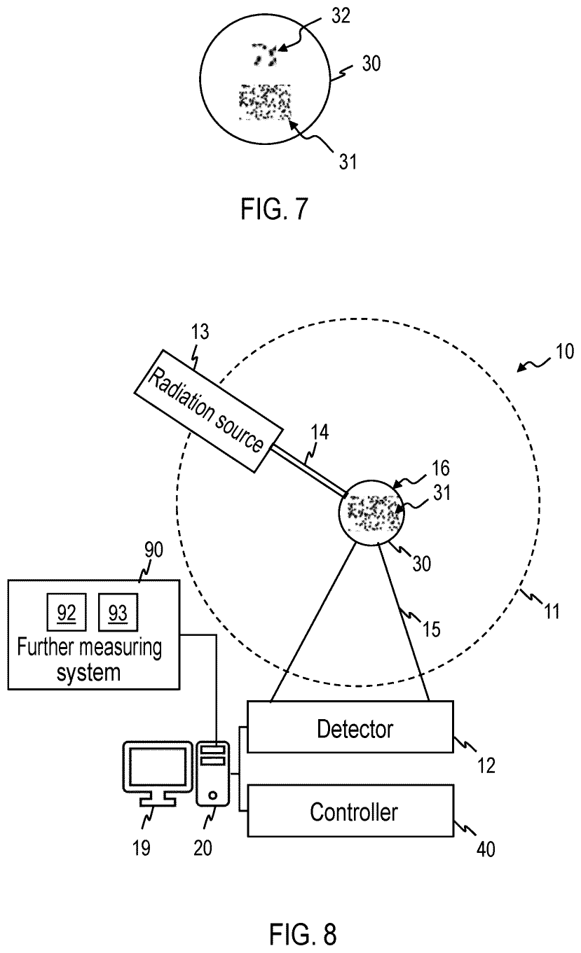

The evaluation device 20 can alternatively or additionally be configured to use approximative methods. In this case, an initial estimation of the pose, which need not depend on the diffraction pattern of the nonperiodic volumetric diffraction structure 31, can be refined further. The initial estimation can be generated from an additional measuring system with coarser resolution or with a further diffraction structure, as will be described in even greater detail with reference to FIGS. 7 and 8. The initial estimation can also be derived from actuating signals of at least one actuator.

The evaluation device 20 can alternatively or additionally be configured to carry out an iterative procedure for determining the pose. An estimation of the pose can be refined further and further.

The aforementioned techniques can be combined with one another.

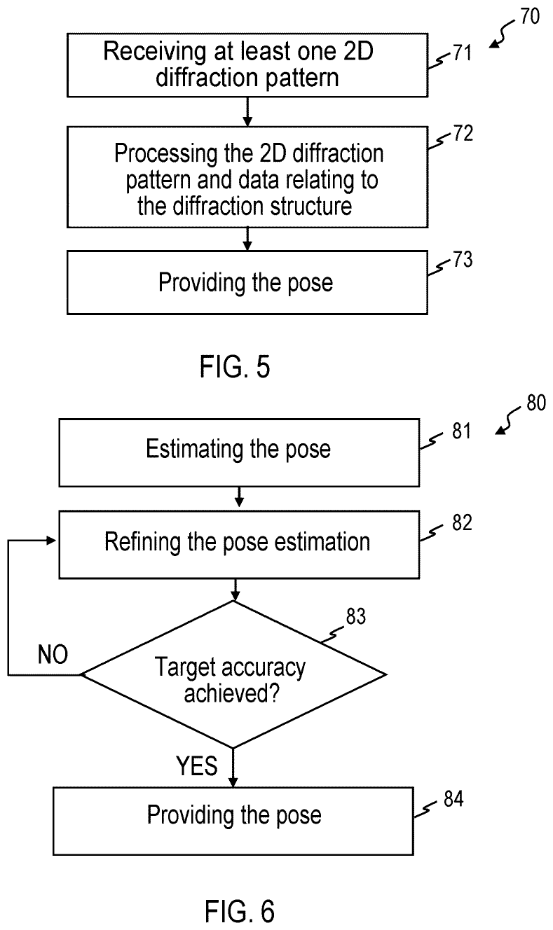

FIG. 5 is a flowchart of a method 70 according to one embodiment. The method 70 can be carried out automatically by the evaluation device 20.

At 71, the evaluation device 20 receives at least one two-dimensional diffraction pattern. The at least one two-dimensional diffraction pattern is captured by a detector 12 and is the result of a diffraction of coherent radiation at the nonperiodic volumetric diffraction structure 31.

At 72, the two-dimensional diffraction pattern is processed. Data relating to the configuration of the nonperiodic volumetric diffraction structure 31 are also used for pose determination.

At 73, the determined pose is provided. This can include an output via a human-machine interface 19 or the provision of the pose to at least one controller 40.

FIG. 6 is a flowchart of a method 80 according to one embodiment. The method 80 can be carried out automatically by the evaluation device 20.

At 81, the pose is estimated. The pose can be estimated by the use of a further measuring system having a lower resolution. Alternatively, a plurality of diffraction structures can be provided in the diffractive element 30 in order firstly to ascertain an estimation for the pose and then to refine this with the aid of the diffraction patterns resulting from the diffraction at the nonperiodic volumetric diffraction structure 31.

At 82, the pose estimation is refined. This can be done in various ways, in particular using the data 60 which define the diffraction structure 31 or are dependent on the diffraction structure 31 in some other way.

At 83, it is possible to check whether a desired target accuracy has been achieved. The check can include ascertaining an error measure that quantifies a difference between the captured diffraction pattern and the diffraction pattern ascertained computationally for a candidate pose. Any appropriate difference metric for images can be used to quantify the difference.

If the desired target accuracy has not yet been achieved, the method can return to step 82.

Otherwise, at step 84, the determined pose can be provided, as explained with reference to step 73.

In addition to the nonperiodic volumetric diffraction structure, the diffractive element 30 can include further features that can facilitate the pose determination or be used for the pose determination.

FIG. 7 schematically shows a diffractive element 30 including the nonperiodic volumetric diffraction structure 31 and at least one further diffraction structure 32. The at least one further diffraction structure 32 can be a periodic diffraction structure. A diffraction pattern generated by diffraction at the at least one further diffraction structure 32 can be used for estimating the pose. The estimation of the pose can subsequently be refined.

As an alternative or in addition to the use of the additional diffraction structure 32 in the diffractive element 30, an estimation of the pose can also be obtained using further contactless-measurement and/or tactile measuring systems.

FIG. 8 shows a system 10 which, in addition to the component parts described with reference to FIGS. 1 and 2, includes a further additional measuring system 90 for pose determination. The further additional measuring system 90 may have a resolution which is less accurate than the resolution attainable by evaluation of the at least one interferometric diffraction pattern. The further additional measuring system 90 can be a system that measures without contact, in particular a system that measures using optical methods.

An estimation of the pose of the diffractive element 30 ascertained by the additional measuring system 90 can be used by the evaluation device 20 in order to refine the estimation. For example, the evaluation device 20 can restrict the determination of computationally expected reference diffraction patterns from the known configuration of the diffraction structure 31 such that only part of the pose space in the vicinity of the pose estimation ascertained by the additional measuring system 90 is sampled in a targeted manner. Processing times can be reduced as a result.

The additional measuring system 90 can include a further radiation source 93. The further radiation source 93 can be a source of coherent or incoherent radiation. The further radiation source 93 can include at least one further laser or one further frequency comb.

The additional measuring system 90 can include one further detector 92 or a plurality of further detectors 92. The additional measuring system 90 can be for example a triangulation system which operates with incoherent illumination, or can use coherent radiation.

If the additional measuring system 90 has a lower resolution in a first of the three spatial directions compared with the two orthogonal spatial directions, the evaluation of the diffraction pattern captured by the detector 12 for pose determination can be used in a targeted manner to improve the resolution of the pose determination in the first spatial directions. For this purpose, the radiation source 13 and/or the detector 12 can be arranged relative to the components of the system 90 such that the high measurement accuracy resulting from the processing of the diffraction patterns of coherent radiation is attained in any case for those spatial directions for which the additional measuring system 90 yields a lower resolution.

The system 10 can be configured such that it combines angulation and lateration.

For this purpose, for example, the additional measuring system 90 can be configured to determine a distance with respect to a target body, wherein the target body can be the diffractive element 30 or some other optical element connected thereto in a stationary fashion, for example a reflector.

The distance measurement can be carried out in various ways, for example using time-of-flight techniques, lidar techniques or using at least one frequency comb generator. Via lidar, for example, the additional measuring system 90 can carry out a distance measurement which does not necessarily have a high resolution but is unambiguous over all distances in the detection volume 11. This measurement is supplemented by an interferometrically accurate determination using coherent radiation in the system 10. For this purpose, the radiation source 13 can include a frequency comb generator 13. These two measurement approaches can be realized in integrated, for example photonically integrated, form. This enables a compact and robust realization.

A further advantage of the combination of the additional measuring system 90 with a system that uses coherent radiation and thus interferometric methods (for example using a frequency comb generator) is that a permanent self-calibration of the system is achievable. For this purpose, for example, optical and/or modulation frequencies of the FMCW LiDAR could be continuously compared with time standards. Such time standards are available via time distribution networks, for example. This makes it possible to dispense with transfer standards during a factory calibration of the system 10. The need for recurring factory calibrations can even be completely obviated.

The beam of the additional measuring system 90 that is required for the distance measurement can be collimated and tracked. However, it can also be defocused, such that the need for tracking can be obviated. Moreover, just an open-air section can be introduced for the distance measurement, wherein an optical fiber, for example a light guiding fiber, can be used for one of the paths between additional measuring system 90 and target object. As a result of the evaluation of the diffraction patterns, by way of radio-based methods it is possible to generate the phase coherence of the light between the target object and a base unit with the further detector 92, with respect to which the distance is measured. For this purpose, in the base unit of the additional measuring system 90, the possibility can additionally be afforded of rotating a polarization plane of the local light field, since the polarization plane of the incident light can generally be oriented in any desired manner.

The availability of coherent radiation 14 with exactly known frequency and thus wavelength in the system 10 affords the further advantage that by using the coherent radiation, from the at least one two-dimensional diffraction pattern, a good resolution of both position and orientation of the diffractive element 30 is achievable. In the system 10, the coherent radiation 14 is used to generate a spatially granular light distribution captured by the at least one detector 12. The detector 12 or the detectors can be embodied as multispectral cameras or single-photon detector (SPAD=“Single-Photon Avalanche Diode”) arrays. In conjunction with a multispectral illumination of the diffraction structure 31, this has the effect that it is possible to achieve a measurement of the position and orientation with high accuracy. Optionally, the pose can be reconstructed on the basis of the known used laser wavelengths of the radiation source 13 via a multispectral measurement of the diffraction patterns.

Instead of a frequency comb generator, the radiation source 13 can also include one or more laser diodes.

The additional measuring system 90 is optional, as has been described with reference to FIGS. 1 to 3.

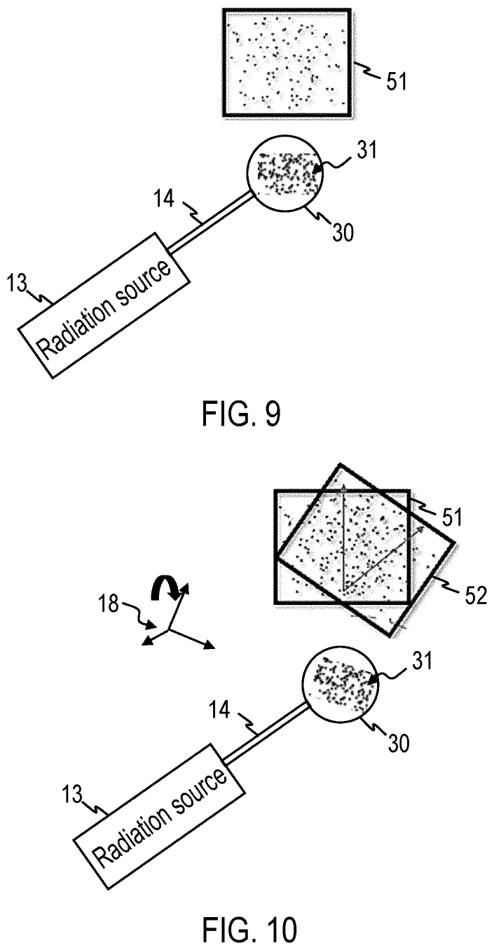

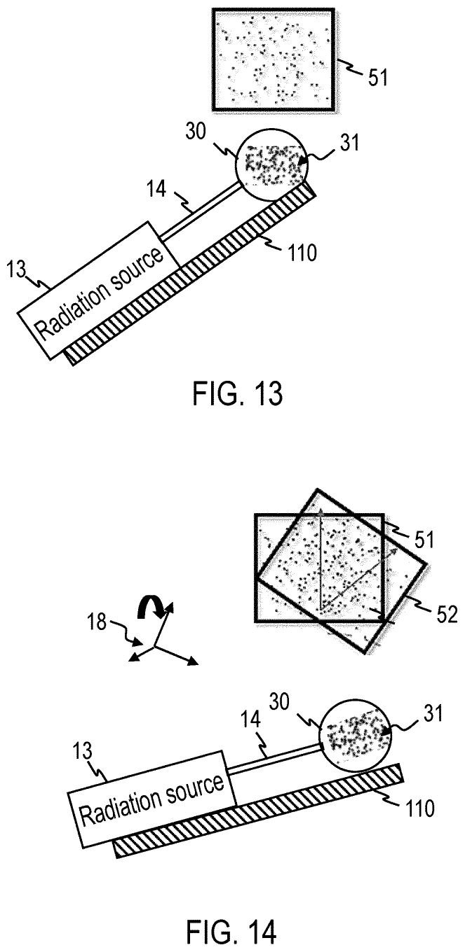

The mode of operation of the system 10 will be described in greater detail with reference to FIGS. 9 to 14. These figures elucidate the mode of operation for possible embodiments in which the radiation source 13 is not carried along during a movement of the diffractive element 30 (FIGS. 9, 10, 11 and 12), and a further embodiment, in which the radiation source 13 is connected to the diffractive element 30 in a stationary fashion such that during translational movement and/or rotation of the diffractive element 30, a direction of incidence of the coherent radiation 14 on the diffractive element 30 remains unchanged. The last-mentioned embodiment will be described in greater detail with reference to FIGS. 13 and 14.

FIGS. 9 and 10 elucidate a determination of a rotational pose (that is, orientation) of the diffractive element 30 in a coordinate system defined by the detector 12 or the detectors 12. Capture by one detector is illustrated by way of example, this capture being sufficient for determining the orientation of the diffractive element 30. As is illustrated in FIG. 9, diffraction of the coherent radiation 14 at the nonperiodic volumetric diffraction structure 31 results in a diffraction pattern 51 in a detector plane of the detector 12. The orientation of the diffractive element 30 can be determined from the diffraction pattern 51 in combination with the data which define the nonperiodic volumetric diffraction structure 31. This can include the determination of three Euler angles, for example.

As illustrated in FIG. 10, the diffraction pattern 51, 52 in the detector plane changes if an orientation of the diffractive element 30 relative to the detector 12 changes. The orientation of the diffractive element 30 can once again be determined from the diffraction pattern captured by the detector. This can include the determination of three further Euler angles, for example. In this way, it is possible to determine the orientation of a coordinate system 18 associated with the diffractive element 30 relative to a stationary coordinate system defined by the at least one detector 200.

A determination of the orientation can be carried out, as illustrated in FIGS. 9 and 10, using just one detector 12 even when the radiation source 13 is not fixedly connected to the diffractive element 30.

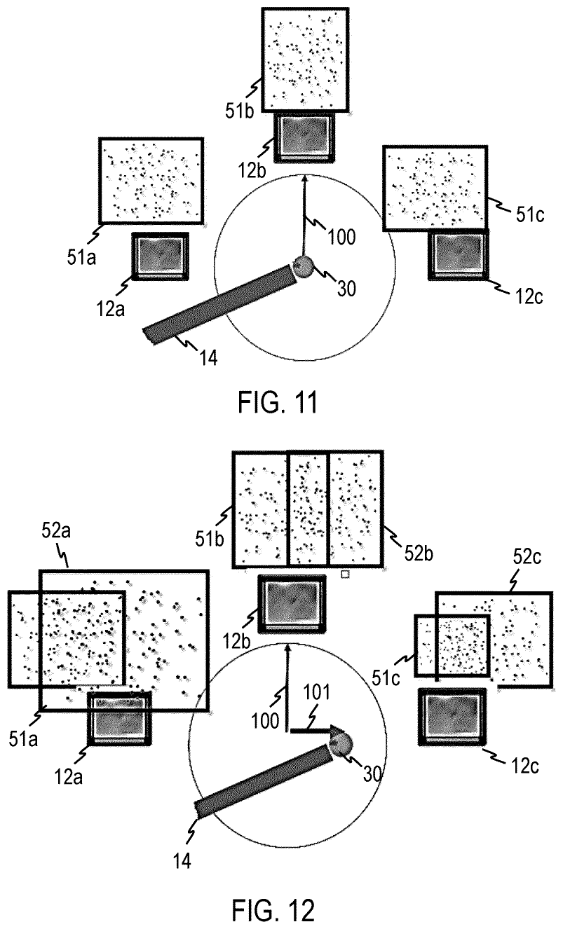

FIGS. 11 and 12 illustrate the determination of a translational position of the diffractive element 30 in a detection volume when the radiation source 13 is not fixedly connected to the diffractive element. A direction of propagation of the coherent radiation 14 is tracked in this case. This can be done in a control loop (for example on the basis of a captured intensity) or on the basis of a pose estimation captured by an additional measuring system.

The translational pose can be determined using at least two detectors. It is also possible to use more detectors. Three detectors 12a, 12b and 12c are illustrated by way of example. From the diffraction patterns 51a, 51b, 51c captured by these detectors, it is possible to determine the position of the diffractive element 30 in a reference coordinate system, for example the coordinate system defined by the at least one detector 200.

A translational movement 101 of the diffractive element in the detection volume leads to a change in the diffraction patterns in the detector planes. This change is schematically represented by the additional diffraction patterns 52a, 52b and 52c in FIG. 12. From the diffraction patterns captured by the detectors 12a, 12b and 12c, it is possible in each case to calculate the pose of the diffractive element 30 in the detection volume, wherein data about the configuration of the diffractive element 30 are used for calculating the pose (in particular the position).

The detection volume can be spherical, as illustrated in FIGS. 11 and 12. A radius 100 of the detection volume can be more than 1 m, more than 1.5 m or more than 2 m.

FIGS. 13 and 14 illustrate a situation in which the incident beam of coherent radiation 14 used to illuminate the nonperiodic volumetric diffraction structure 31 moves as well during movement of the diffractive element 30. To put it another way, an embodiment of the system 10 is used in which the radiation source 13 (which in this case for example can also involve an exit field of an optical fiber) is fixedly positioned relative to the diffractive element 30. Such positioning can be achieved for example using a common carrier 110 or a coupling element 110. The carrier 110 or the coupling element 110 is advantageously formed from a material having low thermal expansion. Invar or a material having similarly low thermal expansion, for example, can be used for the carrier 110 or the coupling element 110. The carrier 110 or the coupling element 110 can have for example a coefficient of linear expansion of 10·10⁻⁶/K or less.

In a manner similar to that described with reference to FIGS. 9 and 10, the absolute rotational pose can be calculated in each case from the diffraction pattern captured by a single detector 12. In a manner similar to that described with reference to FIGS. 11 and 12, the translational position in the detection volume can be implemented using a plurality of detectors, for example.

The radiation source 13 generates coherent radiation having one or more wavelengths. The radiation source 13 is sufficiently frequency-stabilized in order to allow a well-defined phase angle of the diffraction pattern over a relevant measurement period in which the diffraction pattern is captured.

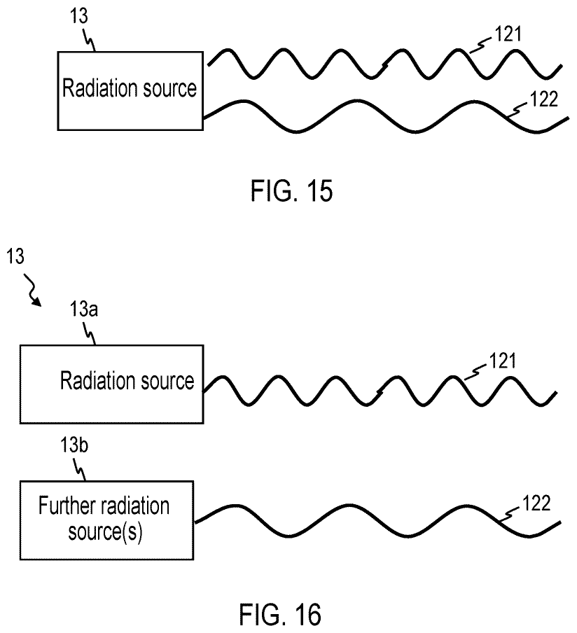

FIG. 15 shows an embodiment of a radiation source 13 which outputs radiation components 121, 122 having different wavelengths. Color demultiplexing can be used if a plurality of wavelengths are used. As a result, an additional degree of freedom is used in detection. The diffraction patterns can be evaluated for different color channels of the detector. This can be done as described above. A computational determination of expected diffraction patterns from the data 60 which can define the configuration of the nonperiodic volumetric diffraction structure 31 can be carried out separately for the different wavelengths.

The different radiation components 121, 122 can be phase-stable with respect to one another. This additionally allows the use of synthetic wavelengths which can be generated by way of the different radiation component 121, 122. In a manner similar to digital holography, this can achieve good precision.

The different radiation components 121, 122 can be output by the same physical unit. For example, the radiation source 13 can include a frequency comb generator that outputs the radiation component 121, 122.

As illustrated in FIG. 16, the system can also include physically separate radiation sources. For example, a first radiation source 13a can be provided, which outputs a radiation component 121 having a first wavelength, and also at least one further radiation source, which outputs a radiation component 122 having the second wavelength. The first radiation source 13a can include a first laser diode. The second radiation source 13b can include a second laser diode. The radiation sources 13a, 13b can be coupled in order to bring about phase stability between the radiation components 121, 122.

The systems and methods described in detail can be used for pose determination in industrial manufacturing plants and/or quality control systems or in medical engineering systems. The determined pose can be supplied to a controller 40, which actuates at least one actuator depending on the determined pose.

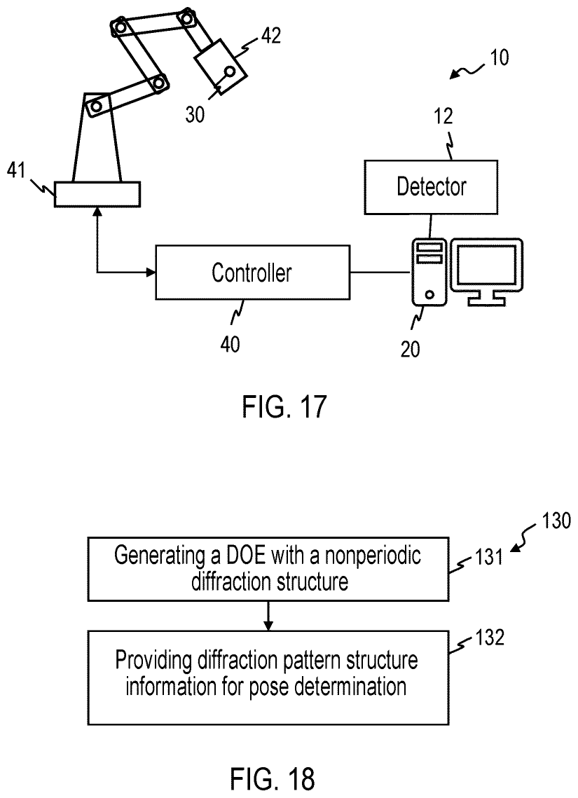

FIG. 17 is a schematic illustration of a system 10 including a robot arm 41. Instead of a robot arm 41, other mechanisms can also be used to move a target object 42 in a working region.

The pose determined by the evaluation device 20 can be supplied to a controller 40, which is configured to generate at least one control signal for an actuator (for example of the robot arm) depending on the determined pose. In this way, the pose of a target object 42, for example a workpiece, tool or surgical instrument, can be checked and, if necessary, adjusted.

As is illustrated in FIG. 17, the diffractive element 30 can be securely connected to the target object 42 or formed integrally with the latter. Since the diffractive element 30 is typically arranged offset with respect to a predefined point of the target object 42 (for example the volume center point, a center of gravity or a tool tip), it is often necessary to determine all three translational and all three rotational coordinates of the diffractive element 30 in order to determine the position of the predefined point of the target object 42 in the detection volume.

Pose determination systems and methods use a diffractive element 30 configured in a purposeful manner. The nonperiodic volumetric diffraction structure can be formed in such a way that it allows a unique assignment to any desired poses in the detection volume on the basis of at least one diffraction pattern if data defining the configuration of the nonperiodic volumetric diffraction structure are available for the evaluation. These data can be provided during the production of the diffractive element 30 for use by the pose determination system or method.

FIG. 18 is a flowchart of a method 130. The method 130 can be carried out automatically by a manufacturing system for the diffractive element 30.

At 131, a diffractive optical element having a volumetric nonperiodic diffraction structure is produced. Step 131 can include determining the nonperiodic volumetric diffraction structure. As explained above, the diffraction structure can be determined for example by respective desired reference diffraction patterns being defined for a multiplicity of possible positions of the detector area of the detector 12. The multiplicity of possible positions of the detector cover the entire surface area of the detection volume 11 or a solid angle range corresponding to the desired dynamic range of the orientation ascertainment. A diffraction structure that will result in these reference diffraction patterns can be ascertained by back-calculation. Other techniques can be used. By way of example, from the surface area of the detection volume, the detector area of each detector 12 and the pixel size of each detector 12, it is possible to estimate what information content the diffraction structure needs to have in order to allow a unique assignment of poses to in each case exactly one captured diffraction pattern. The diffraction structure can then be generated pseudo-randomly such that it has this required information content (that is, for example, the corresponding entropy).

At 132, data which are dependent on the configuration of the nonperiodic volumetric diffraction pattern are provided. These data can be used by the system 10 for pose determination. In this case, the data which are dependent on the configuration of the diffraction pattern can be used in various ways, as has already been described in detail. By way of example, the expected reference diffraction patterns can be calculated for any desired pose, and can then be compared with the captured diffraction pattern.

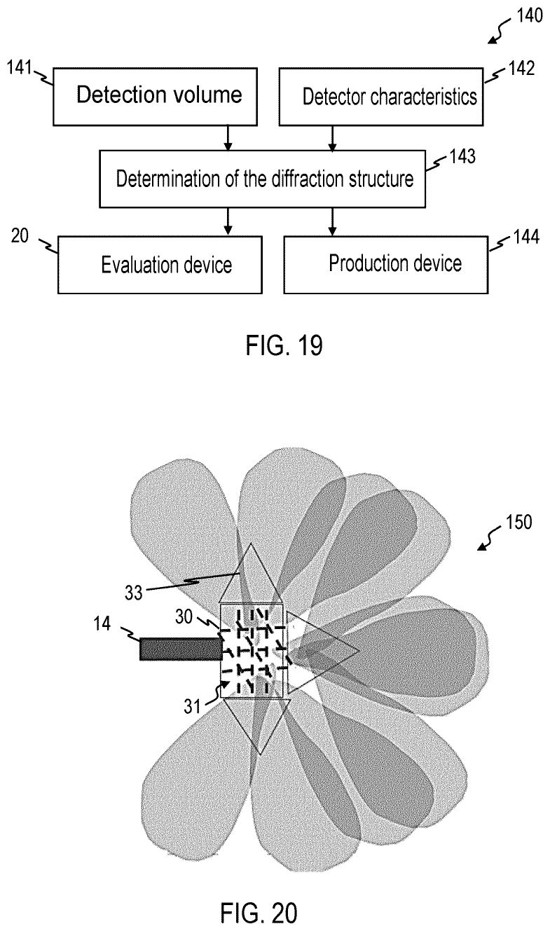

FIG. 19 is a schematic block diagram illustrating a system 140 which can be used for defining and producing the diffractive element 30.

A computer 143 that carries out a determination of the nonperiodic volumetric diffraction pattern receives both information about the detection volume 141 and characteristics 142 of the used detector 12 or of the used detectors 12 as input variables. The characteristics 142 of the detector 12 or of the detectors 12 can include a detector area and a pixel size, for example. The characteristics 142 can also include a number of different color channels.

The computer 143 then determines the nonperiodic volumetric diffraction structure on the basis of the input variables mentioned. For this purpose, for example, it is possible to determine a three-dimensional arrangement of scattering centers in a glass or quartz material.

The configuration of the nonperiodic volumetric diffraction structure determined is used for controlling a manufacturing apparatus 144. The manufacturing 144 can be configured to generate the nonperiodic volumetric diffraction structure by laser writing or by 3D printing, for example.

The configuration of the nonperiodic volumetric diffraction structure determined is also made available to the evaluation device 20, which is configured to computationally use the known configuration of the diffraction structure in the pose determination.

The production of the diffractive element 30 can also include quality control. Accordingly, the system 140 can additionally include a checking station, which for some poses checks whether the diffractive element 30 produced actually leads to the expected diffraction patterns. The checking station can include a microscope for visual inspection of the manufactured diffraction structure.

The diffractive element 30 can have different surface shapes and geometries. For example, the diffractive element 30 can have a geometry that contributes to a radiation of diffraction patterns over a desired solid angle range. For this purpose, the diffractive element 30 can for example be embodied in such a way that it has a faceted surface. The diffractive element 30 can have a surface that includes polyhedral regions.

FIG. 20 is a schematic illustration of a diffractive element 30 that is produced (in particular shaped) in such a way that its surface has polyhedral regions 33. Thus, it is possible to achieve a characteristic in which diffraction patterns are radiated over a relatively large solid angle range 150.

As has been described with reference to the figures, pose determination systems and methods use a diffractive element. The diffractive element includes a diffraction structure 31 which is nonperiodic, such that in the detection region no repetitive diffraction pattern arises over an area region which corresponds to the detector area of the detector 12 or is larger than the detector area. The diffractive element has a structure which can be generated randomly or pseudo-randomly (for example in order to attain a desired information content) during production, but is known and follows a reproducible configuration rule. Herein lies a difference to diffractive structures that use random interference at two-dimensional surfaces or three-dimensional structures. The diffraction image generated by the diffractive element can cover a solid angle of at least 2π, at least 3π or 4π. On account of the configuration of the diffractive element and its application, shading may be accepted.

The nonperiodic volumetric diffraction structure 31 can be embodied, as described, depending on the configuration of the system 10, in particular depending on a size of the detection volume 10 and depending on a detector area and/or pixel size and/or number of color channels of the at least one detector 12. By way of example, the nonperiodic volumetric diffraction structure 31 can have an effective mean grating constant and a dimension which are dependent on the detection volume 11 and an image field of the detector 12.

The intensity distribution resulting from the coherent illumination of the diffraction structure 31 can be calculated in the detection volume. For this purpose, a Gerchberg-Saxton method or some other technique can be used, for example, which takes into account the angular ranges over which an irradiation by the coherent radiation and/or a detection are/is possible.

The diffractive element can include a plurality of different diffraction structures. These can have different effective mean grating constants. The diffractive element can include the nonperiodic volumetric diffraction structure 31 as a primary structure in order to attain one-to-one correspondence of the pose determination in the detection volume 11. In addition, a secondary structure, for example a supergrating, can be provided in order to enable a simplified estimation of the pose with less accurate resolution.

The configuration of the diffractive element 30 is known from a configuration standpoint, for example from the production method. Tolerances of the desired configuration can be quantified via inverse calculation of the diffraction image or confocal microscopy, for example.

The diffractive element is advantageously formed from a mechanically and/or thermally stable material. In particular, the diffractive element can be formed from a glass or quartz material or from some other material having low thermal expansion. As a result, high reliability of the pose determination is achieved even in the event of temperature variations of a few kelvins which may be caused for example by the coherent radiation 14 or by fluctuations in the ambient temperature.

A source of the coherent radiation can optionally be securely connected to the diffractive element 30 via a mechanical coupling element 110. For example, the coupling element can consist of a material such as Invar or some other material having low thermal expansion, for example comparable to or less than that of Invar.

The diffraction pattern(s) can be captured by at least one detector 12. A plurality of detectors 12 can be positioned along a surface of the detection volume. Surface normals of the detector areas can be tilted with respect to one another. The detectors can be in the form of cameras, for example lensless cameras.

A plurality of detectors 12 can be used in order to cover all degrees of freedom, in particular all three translational and all three rotational degrees of freedom.

The systems and methods can be used not only to determine the pose of the diffractive element but also to ascertain higher moments. For example, the systems and methods can also be used to ascertain translational and/or rotational speeds and/or accelerations. These can also be output via the human-machine interface 19 or provided to the controller 40.

The systems and methods can use an estimation of the pose and refine that estimation. The estimation can be effected as a measurement using the additional measuring system 90, which can likewise measure without contact (for example optically). Alternatively or additionally, the estimation can be derived from a kinematic chain of actuators to which the evaluation device 20 can be communicatively connected and which changes the pose of the diffractive element 30.

The diffractive element 30 can be produced by laser writing or other techniques, such as 3D printing. Such techniques allow the formation of a nonperiodic volumetric diffraction structure which has a dimension that can be less than 5 cm, less than 3 cm, less than 2 cm, less than 1 cm, less than 5 mm, less than 3 mm, less than 1 mm, less than 0.5 mm, less than 0.3 mm or less than 0.1 mm, but which, using conventional detector areas and pixel sizes, may allow a one-to-one correspondence between pose and diffraction pattern over a detection volume with a radius of at least 1 cm, at least 3 cm, at least 5 cm, at least 10 cm, at least 30 cm, at least 50 cm, at least 1 m, at least 2 m, at least 3 m or more.

While embodiments have been described with reference to the figures, modifications can be realized in further embodiments. For example, the following modifications can be used alternatively or cumulatively:
fewer than three rotational coordinates and/or fewer than three translational coordinates can be determined. For example, if high accuracy is only of interest for the angular degrees of freedom, the coherent illumination can be positioned such that the diffractive element moves relative thereto. A coarse tracking of the coherent radiation is then sufficient;
the requirement of the one-to-one assignment between pose and diffraction pattern can be relaxed if at least one additional measuring system 90 is used to determine the pose with a lower resolution;
It is possible but not mandatory for the full solid angle to be covered by the diffraction image. For example, a half-space or a smaller angular range may be sufficient to perform a desired pose determination for the respective application. This allows a reduction in the illuminated volume of the diffractive element.

While a description has been given of embodiments which can be used in systems of industrial manufacturing or quality control or medical engineering, the disclosed techniques can also be used in other areas of application.

The present disclosure also encompasses embodiments with any combination of features that are specified or shown in relation to different embodiments. It also encompasses individual features in the figures, even if they are shown there in connection with other features and/or are not mentioned above or below. The alternatives of embodiments described in the figures and the description and individual alternatives of their features can also be excluded from the subject matter of the disclosure or from the disclosed subject matter.

A machine-readable instruction code which can be executed by a programmable circuit for the purpose of carrying out methods according to embodiments can be stored and/or distributed on a suitable medium, such as for example on an optical storage medium or a solid-state medium, which is provided together with or as part of other hardware. The instruction code can also be distributed in other forms, for example in the form of a modulated data signal sequence.

Embodiments of the disclosure make available improved techniques for pose determination, which allow the determination of an absolute pose (in particular of up to six degrees of freedom) with interferometric accuracy.

It is understood that the foregoing description is that of the preferred embodiments of the invention and that various changes and modifications may be made thereto without departing from the spirit and scope of the invention as defined in the appended claims.

1. A pose determination system comprising:
a diffractive element including a nonperiodic volumetric diffraction structure;
at least one detector configured to capture at least one two-dimensional diffraction pattern caused by diffraction of coherent radiation at said diffractive element in a far field; and,
an evaluation device configured to determine a pose of said diffractive element on a basis of said at least one two-dimensional diffraction pattern and data which are dependent on said nonperiodic volumetric diffraction structure.

2. The system of claim 1, wherein said diffractive element is configured such that said at least one two-dimensional diffraction pattern arising at said at least one detector is uniquely assignable to a pose of said diffractive element in a detection volume.

3. The system of claim 1, wherein said diffractive element is configured such that said diffractive element generates no repetitions of said diffraction pattern of the coherent radiation over at least one of a predetermined volume and a predetermined solid angle range.

4. The system of claim 1, wherein said diffractive element is configured such that said diffractive element causes a diffraction pattern over a solid angle range of at least 2π, more than 2π, more than 3π or 4π.

5. The system of claim 1, wherein the diffraction structure includes a pseudo-randomly distributed structure; and, the data used by said evaluation device are dependent on said pseudo-randomly distributed structure.

6. The system of claim 1, wherein said evaluation device is configured to computationally determine six degrees of freedom of said diffractive element for the pose determination.

7. The system of claim 1, wherein said evaluation device is configured, for the pose determination, to:
compare the at least one two-dimensional diffraction pattern with a plurality of two-dimensional reference diffraction patterns which are determined from calibration measurements or are ascertained computationally depending on said nonperiodic volumetric diffraction structure;
process the at least one two-dimensional diffraction pattern captured by said at least one detector via a trained machine learning model; and,
perform an approximative procedure for pose determination.

8. The system of claim 1 further comprising at least one source of the coherent radiation configured to radiate the coherent radiation onto said diffractive element.

9. The system of claim 8, wherein said at least one source is coupled to said diffractive element in a stationary fashion.

10. The system of claim 8, wherein said at least one source is configured to radiate coherent radiation having a plurality of different wavelengths onto said diffractive element.

11. The system of claim 9, wherein said at least one source is configured to radiate coherent radiation having a plurality of different wavelengths onto said diffractive element.

12. The system of claim 1, wherein the system is or comprises an industrial manufacturing system, an industrial measuring system or a medical engineering system.

13. A method for producing a diffractive element for pose determination, the method comprising:
determining a nonperiodic volumetric diffraction structure;
controlling a production device for forming the nonperiodic volumetric diffraction structure; and,
providing data which are dependent on the nonperiodic volumetric diffraction structure for determining the pose of the diffractive element.

14. The method of claim 13, wherein the production device includes a device for laser writing of the nonperiodic volumetric diffraction structure or for three-dimensional printing.

15. A pose determination method comprising:
capturing, via at least one detector, at least one two-dimensional diffraction pattern caused by diffraction of coherent radiation at a diffractive element in a far field, wherein the diffractive element includes a nonperiodic volumetric diffraction structure; and,
determining a pose of the diffractive element on a basis of the at least one two-dimensional diffraction pattern and data dependent on the nonperiodic volumetric diffraction structure.

16. The method of claim 15, wherein the method is carried out by a system having the diffractive element including the nonperiodic volumetric diffraction structure, the at least one detector configured to capture the at least one two-dimensional diffraction pattern caused by the diffraction of the coherent radiation at the diffractive element in the far field, and, an evaluation device configured to determine a pose of the diffractive element on a basis of the at least one two-dimensional diffraction pattern and data which are dependent on the nonperiodic volumetric diffraction structure.
